(19) United States
(12) Patent Application Publication
(10) Pub. No.: US 2024/0184906 A1
(43) Pub. Date: Jun. 6, 2024

(54) SYSTEM AND METHOD FOR MULTIFACTOR PRIVACY RATING

(71) Applicant: MyAppDaddy, Inc.

(72) Inventors: Robert D. Taylor, Los Angeles, CA (US); Gregory A. Martin, Los Angeles, CA (US)

(21) Appl. No.: 18/072,714

(22) Filed: Dec. 1, 2022

(51) Int. Cl. G06F 21/62

(52) U.S. Cl. CPC G06F 21/6218

(57) ABSTRACT

The present disclosure discloses a system for evaluating the treatment of consumer privacy data by third-party apps using an identifier referring to a third-party application; and a grade assigned to an at least one privacy category. The present disclosure also discloses a method for managing privacy assessments of third-party apps; reviewing primary and secondary source materials concerning treatment of consumer privacy data; facilitating consistent evaluation with rigorous guidelines; and recording the third-party app's consumer privacy data treatment against various criteria by category.

### BACKGROUND OF THE INVENTION

### 1. Field of Invention

Aspects of the present disclosure generally relate to technical repositories or databases of records concerning standardization of data concerning treatment of consumer privacy by third-party apps.

### 2. Description of the Related Art

Third-party interactive technologies or applications (“apps”) for use with interactive technologies are generally known in the related art. Consumers of third-party apps have grown increasingly concerned with consumer privacy. To help combat this, privacy rating systems have begun to emerge. For example, the following are known in the related art: application Ser. Nos. 10/586,072; 10/445,526; 10/423,996; 10/242,228; 10/169,788; 10/032,172; 9,892,444; 10/498,769; 10/417,445; 10/366,236; 10/243,964; and U.S. Pat. Nos. 9,942,276; 9,571,526; 9,892,444; 9,473,535; 9,356,961; 9,215,548; 9,053,345; 8,925,099; 8,918,632; and 8,793,164. However, such systems known in the related art do not teach or suggest categories to address a multitude of privacy concerns to rate third-party apps.

Privacy scores are also known. Consumer Reports PrivacyGrade (“PG”) website discloses a technical focus with drill-down reports on a per-app basis. PG discloses letter grades. However, unknown is how the grades are determined, and PG does not teach or suggest categories to address and account for a multitude of privacy concerns in a rigorous manner.

Controversies concerning privacy violations are known, such as the FaceApp app controversy in which users were concerned about their data being taken by foreign interests without their consent or knowledge.

Legal terms and policies are known in the related art. However, it is also known that consumers installing an app often do not read terms and conditions. Therefore, it can be seen that there is a need to inform consumers of the risks concerning privacy associated with a particular third-party app and to aid in holding apps accountable for failing to honor their own privacy policies.

Data ownership and proprietary control is a subject of public debate and has resulted in legislation such as Electronic Communications Privacy Act (ECPA); Computer Fraud And Abuse Act (CFAA); Cyber Intelligence Sharing And Protection Act (CISPA); Children's Online Privacy Protection Act (COPPA); California Consumer Privacy Act (CCPA), California Privacy Rights and Enforcement Act (CPRA); and the European Union's General Data Protection Regulation (GDPR).

It is known that when a user installs an app, some apps abuse the user's trust and violate the privacy of the user. This issue can arise when installing a third-party application or during its use. It is known that installing third-party applications involves a privacy concern at the time of installation and throughout the use and life of the app. Privacy violations are known in the related art. GDPR, CCPA, CPRA, and parallel laws concerning privacy are generally known. Malicious code, hacking, and malware is also generally known in the related art. It can be seen then, that there is a need to provide a system and method to help consumers control and manage their privacy. It can also be seen that there is a need for consumers to leverage a repository of data with assessment records for different aspects of privacy. It can be seen that there is a need to address privacy ratings or grades for such apps in relation to varied categorical considerations in light of a third-party app's stated policy and adherence to same. It can also be seen that there is a need for a system to facilitate examining privacy grades based on multiple factors. It can be seen that there is a need to find and call out deviations from stated policies of third-party apps, and to provide an infrastructure for an analyst to record pointed observations concerning privacy policies compared to their actual market use and/or exploitation in violation of, or as a deviation from, their claimed policies. Furthermore, it can be seen that there is a need to address any combination of the foregoing needs alone or in combination.

### SUMMARY OF THE PRESENT INVENTION

The present disclosure seeks to resolve the need for consumers to have a high-quality rating system upon which to refer to privacy assessment information for consumers to be more informed in the control and management of their privacy. There is also a need for a system to permit analysts to evaluate and record such information in order to provide such information to consumers using key aspects or categories.

The present disclosure provides a categorical grading system with a repository of data with categories to evaluate multiple aspects of privacy concerns on a per-app, per-category basis. Each category can be graded according to specific criteria using the system and method of the present disclosure.

An aspect of the present disclosure is to provide a system and method to help consumers control and manage their privacy based on a comprehensive privacy grading framework.

Another aspect of the present disclosure is to aid consumers to understand different aspects of how privacy concerns are treated.

A further aspect of the present disclosure is to leverage a repository of data with multiple dimensions to address differing aspects of privacy concerns ranging from ownership, use of data, notice concerning privacy issues or handling of one's data, and to draw on analyst data concerning the business model associated with the app as it related to privacy concerns.

An additional aspect of the present disclosure is to provide privacy ratings or grades for third-party apps, to provide consumers with the ability to refer to privacy grades based on overall and categorical grades, and to provide a platform for an analyst to closely examine and record assessments of privacy policies, to log findings in a data repository, and to determine ratings based on those findings and assessments.

Another additional aspect of the present disclosure is to extract, research and otherwise identify findings including: legal terms, regulatory and government disclosures, marketing and other declarations by third-party interactive technology providers for analysis of privacy policies and to provide granular grading of sub-categories of privacy based thereon.

Another further aspect of the present disclosure is to provide an infrastructure for an analyst to record pointed observations concerning privacy policies on a continuum of ideal to exploitative.

### BRIEF DESCRIPTION OF THE DRAWINGS

The aspects and advantages of the present disclosure will become more apparent through the detailed description, the drawings, and the reference numerals which correspond to the drawings and the detailed description, which are provided as non-limiting illustrations as follows:

FIG. 1 is a possible embodiment of a method of the present disclosure;

FIG. 2 is a possible embodiment of a system of the present disclosure with analyst user interface;

FIG. 3 is a possible embodiment of a system of the present disclosure with end user interface providing an overall grade and app-specific privacy grades;

FIG. 4 is a possible embodiment of a system of the present disclosure with end user interface providing a consumer-facing overall app privacy grade with categories and category grades;

FIG. 5 is a possible embodiment of a system of the present disclosure with end user interface showing findings regarding a third-party app treatment of consumer privacy data (CPD);

FIG. 6 is a possible embodiment of a system of the present disclosure with end user interface showing excerpts regarding a third-party app policy;

FIG. 7 is a possible embodiment of a system of the present disclosure with end user interface with options providing alternatives for a given third-party app;

FIG. 8 is a possible embodiment of a system of the present disclosure with end user interface with search function;

FIG. 9 is a possible embodiment of a system of the present disclosure with end user interface with notifications; and

FIG. 10 shows a possible embodiment of the present disclosure with numeric values mapped to letter grades.

### DETAILED DESCRIPTION OF THE PREFERRED EMBODIMENTS

In the following description of the preferred embodiments, reference is made to the accompanying drawings that form a part hereof, in which is shown by way of illustration specific embodiments in which the invention may be practiced. It is to be understood that the description and the drawings are not the only way the present disclosure may be practiced. The detailed description is to provide guidance to understand concepts to implement the specifics of the invention. It is to be understood that other embodiments may be utilized and structural changes may be made without departing from the scope of the present disclosure.

The teachings of the present disclosure will, when viewed by one skilled in the pertinent art, allow that person to appreciate the scope of the present disclosure covers any aspect of the present disclosure. Any number of aspects may be practiced without departing from the essence of the present disclosure. Any given aspect of the present disclosure can be practiced using a different functionality, structure, or structure and functionality in addition to the present disclosure. Any aspect of the present disclosure should be understood as embodied by one or more elements of a claim.

References throughout the specification to “interesting embodiment”; “possible embodiment”; “preferred embodiment”; “some embodiments”; “an embodiment”; and like reference to “embodiment” are non-limiting examples to aid in understanding the present disclosure, and do not necessarily indicate a preference of one embodiment over another, or preferred over other aspects. An “embodiment” provides that there can be one or more embodiments that can involve the given element or aspect of the invention. Thus, multiple instances of “an embodiment” and like reference do not necessarily refer to the same embodiment.

This specification provides for exemplary definitions with respect to the present disclosure, explained throughout this specification. The description of the preferred embodiments of the present disclosure is being presented for the purposes of illustration and description. It is not intended to be exhaustive or to limit the invention to the precise form disclosed. Many modifications and variations are possible in light of the above teaching, it is intended that the scope of the invention is not, and need not be, limited by this detailed description, but by the claims and the equivalents to the claims which relate to the present disclosure. The present disclosure can be broadly implemented in a wide range of technologies, networks, and configurations.

The term “app” can include third-party interactive technologies and can refer to a third-party software application as identified for grading in connection with privacy categories. The term “app” can refer to online applications, mobile applications, desktop applications, websites, devices, and other interactive technologies.

The term “category” or “privacy category” as used in this specification generally refers to an aspect of an application capable of having an associated assessment and/or grade. The present disclosure need not be limited to binary or gradient assessments of a given category 201. To provide an overview, categories can refer to: control, use, notice, business model, invasiveness, character, security, permanence, alignment, agency, and transparency. Each of these categories is non-limiting and are further described below. These categories are supported by concrete systems storing such information in non-transient format; and in any combination can constitute the present disclosure. In most preferred embodiments, categories will have corresponding assessment records that describe the extent to which each category applies in favor or disfavor of consumer privacy interests.

The term “CPD” as used herein can refer to consumer privacy data; CPD is to be broadly construed as including personal privacy information or any information considered private, confidential, or otherwise proprietary sensitive information not widely known. CPD can refer to any information of a consumer, by way of non-limiting illustration: session ID, IP address, email, username, name, address, DOB, SSN, unique ID, purchase history, browsing history, internet browser, device operating system, zip code, region, geography, state or province, country, marketing preferences, cookie information, social profile, apps installed or used, cross-reference, or any other flag of consent or opt in.

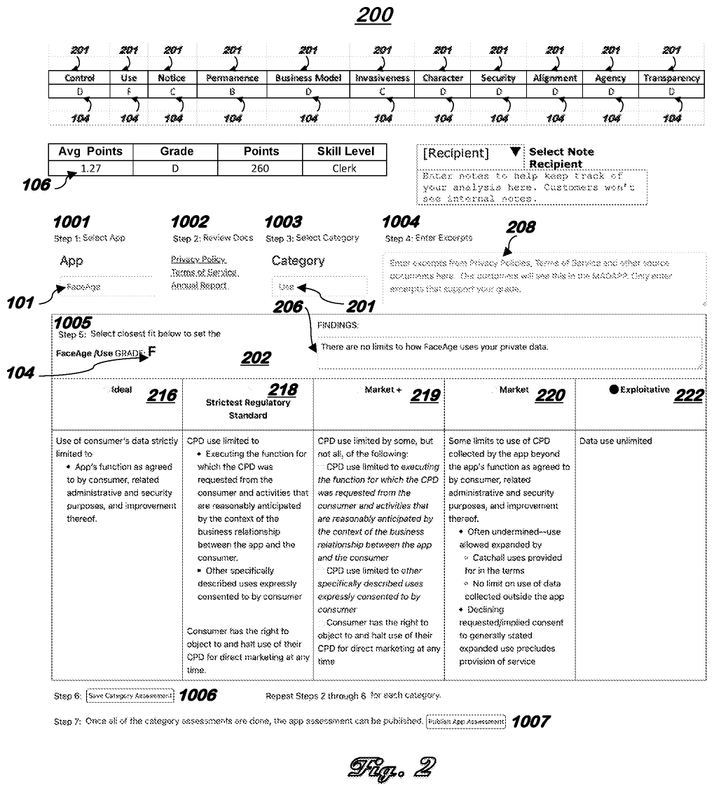

Privacy performance standard 400 can describe performance in relation to an objective standard for grading treatment by CPD in connection with a third-party app identifier. In this context, the standard can be an objective measurable set of one criterion or more than one criterion (Table 1). For example, there can be a gradation from ideal to exploitative along a gradient described by language (for example, as shown in Table 1). Portions of as displayed via user interface 200. For example, FIG. 2 shows a non-limiting example of privacy performance standard 400. There can be more than one privacy performance standard 400. Objective measurable standards for at least one or more privacy performance standard 400 can be set forth in the user interface 200 in reference to standard set forth per each graded category 201. There can be multiple categories 201, such as a first category, second category, third category, . . . through and including an Nth category for any number of categories and corresponding category grades 104 for each category 201. A benefit of privacy performance standard 400 can be to provide a tangible reference. Privacy performance standard 400 can provide such reference analyst in user interface 200 during the grading process. A benefit of privacy performance standard 400 can be to aid in consistent grading by a subsequent analyst using the same criteria at grading time, in reference to another app identifier 101. In the non-limiting example shown in FIG. 2, exploitative 222 description can be indicated. This can include non-subjective measurements as to how well an app performs towards protecting a consumer's privacy-specifically, in relation to a given category 201 concerning privacy. By way of non-limiting illustration, the present disclosure can provide discrete classes of privacy performance having corresponding descriptions to aid an analyst in grading a specific category during review of a particular app identifier 101 for a particular privacy category 201; for example, ideal 216, strictest regulatory standard 218, “market plus” 219, market 220, or exploitative 222. Privacy grading of a specific category 201 can be performed by using displayed category 201 in analyst user interface 200 to aid an analyst in measuring privacy performance. In a preferred embodiment, one or more indicator of privacy performance can be established as “ideal”; “strictest regulatory standard”; “market+”; “market”; or “exploitation.” A non-limiting example is shown in Table 1 further below. For example, privacy performance standard 400 (FIG. 2) can be displayed and objectively measured against recorded privacy performance 402 wherein treatment of CPD is indicated by findings 206 and/or excerpts 208.

The term “control” as used in relation to category 201 can refer to the extent to which, and the means by which, the consumer grants a license to the use of CPD, including associated data acquired outside of the app made possible by the consumer's provision of data to the app.

The term “use” as used in relation to category 201 can refer to the extent to which CPD is used beyond what is needed for the app's function as agreed to by the consumer, related administrative and security purposes, and improvement thereof.

The term “notice” as used in relation to category 201 can refer to whether app identifier 101 gives express notice regarding a multitude of privacy concerns. Notice can refer to all or part of the terms of an app identifier 101 provider's agreement with consumer regarding, and of its treatment of, CPD. “Notice” as used in relation to category 201 can also refer to other representations, promises, warranties, or statements that otherwise refer to informing a consumer regarding privacy.

The term “business model” as used in relation to category 201 can refer to the extent to which an app can have incentives to record, distribute, sell, or otherwise provide access to user data by further third parties beyond such data necessary for the app to deliver its service.

The term “invasiveness” as used in relation to category 201 can refer to the extent to which CPD is collected outside of the app or otherwise used beyond what is necessary for the app.

The term “character” as used in relation to category 201 can refer to the extent to which the app contravenes its stated policy or other representations, or uses technology, that misleads the user regarding treatment of CPD. “Character” can refer to representations made by the app provider and/or its leaders, management, or representatives in an official capacity.

The term “security” as used in relation to category 201 can refer to the extent to which the app provider uses reasonable means to protect the integrity, availability, and confidentiality of CPD.

The term “permanence” as used in relation to category 201. “Permanence” can refer to whether, when, and the extent to which CPD is deleted upon completion of the consumer's business purposes.

The term “alignment” as used in relation to category 201 can refer to the extent to which a consumer is burdened to enforce protections, and the extent to which consequences provided are proportionate and sufficient to encourage acting in the best interests of consumer privacy.

The term “agency” as used in relation to category 201 can refer to the extent to which the app seeks to protect consumer privacy. “Agency” can also refer to the extent to which the app owner is responsible for every party who accesses user data failing to comply with the data privacy agreement between the app and user.

The term “transparency” as used in relation to category 201 can refer to clarity with which the app owner discloses its policies and practices and can consider the accessibility, language tools, and resources used and/or available to enhance consumer understanding.

The foregoing terms also can have expanded definitions in reference to guideline 202 generally as to each respective category 201.

Only after reviewing the disclosures of this specification would it be obvious to one having ordinary skill in the pertinent art to understand how to make and use the present disclosure consistent with its teachings. The scope and aspects of the present disclosure will thereafter be understood to apply to a broad range of applications and embodiments.

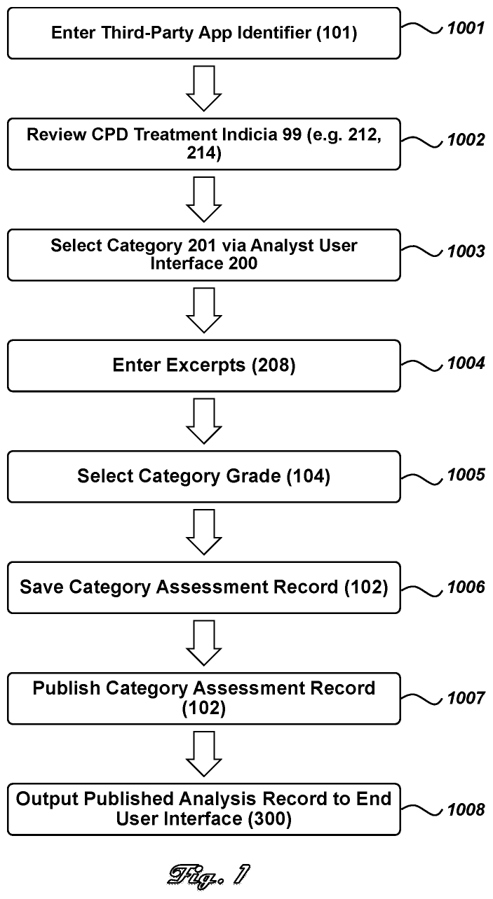

FIG. 1 shows a possible method embodiment of the present disclosure. Steps in FIG. 1 can occur simultaneously and can be used in conjunction with guideline 202 as described in this specification on a per-category 201 basis. By way of non-limiting illustration, the present disclosure can provide a method for managing privacy assessments of third-party apps can have the steps as listed below (FIG. 1):
Enter third-party app identifier 101 (step 1001);
Review CPD treatment indicia 99 (Privacy Policy 212/Terms of Service 214) (step 1002) which can be performed by an analyst;
Select Category 201 in Analyst User Interface 200 (step 1003);
Enter Finding 206 and Excerpt 208 (step 1004);
Enter Category Grade 104 (step 1005);
Save Category Assessment Record 102 (step 1006);
Publish Category Assessment Record 102 (step 1007); and
Output Published Analysis Record to End User Interface 300 (step 1008).

As described herein, steps in a method need not be sequential as described, and the invention can be performed by varying the steps in which said method can be performed.

CPD treatment indicia 99 (FIGS. 1 and 2) can refer to how consumer privacy data is treated. Such indicia 99 can refer to affirmative conduct or an omission, such as a failure to handle CPD in a way that complies with a given policy concerning the app of app identifier 101. There can be an omission of CPD treatment indicia. A benefit of omission of CPB treatment indicia can be to indicate a failure to properly handle CPD. CPD can refer to, by way of non-limiting illustration, a privacy policy 212 and/or terms of service 214 of app identifier 101. CPD treatment indicia 99 can include terms of service, terms of use, privacy policy, and other statements, official or unofficial, regarding treatment of CPD presented on a website, social media, interview, press release, statement, or the like. By way of non-limiting illustration, CPD treatment indicia 99 can be recorded as excerpt 208 (FIG. 2).

FIG. 2 is a possible embodiment of a system of the present disclosure with app identifier 101, analyst user interface 200, category 201, guideline 202, finding 206, excerpt 208, privacy policy 212, and terms of service 214. FIG. 2 generally reflects a non-limiting example of an assessment record. FIG. 2 is a non-limiting illustration of a possible assessment record of the present disclosure directed to the category of “use.”

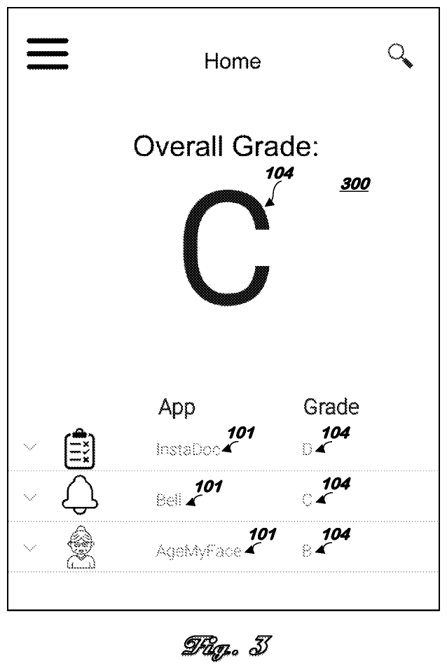

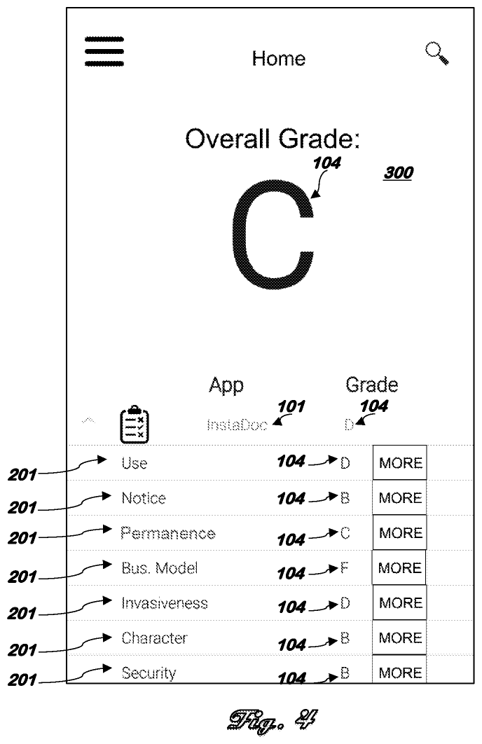

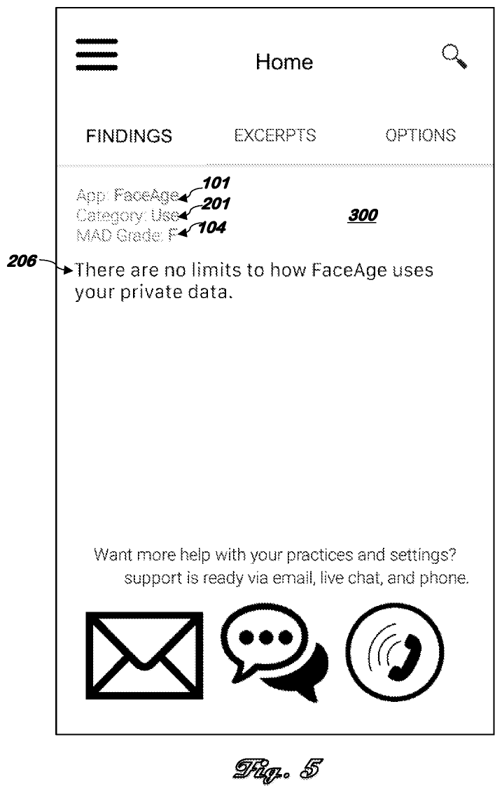

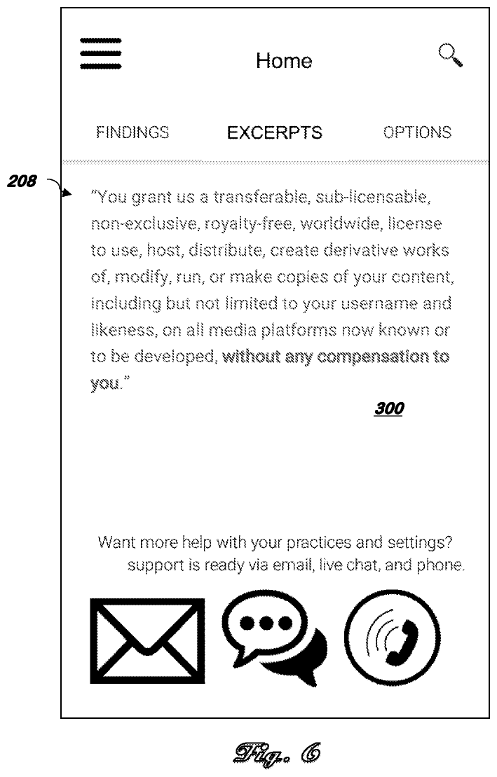

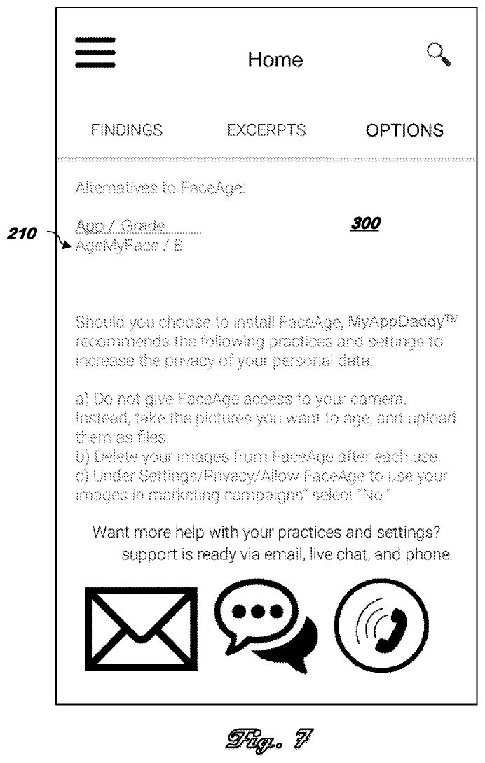

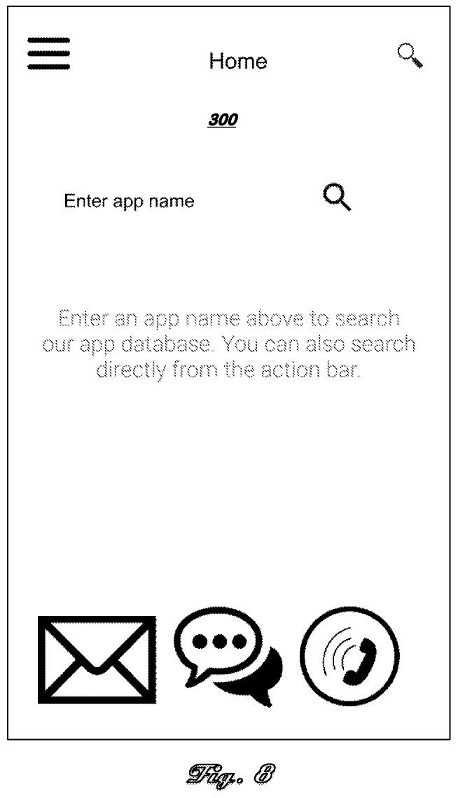

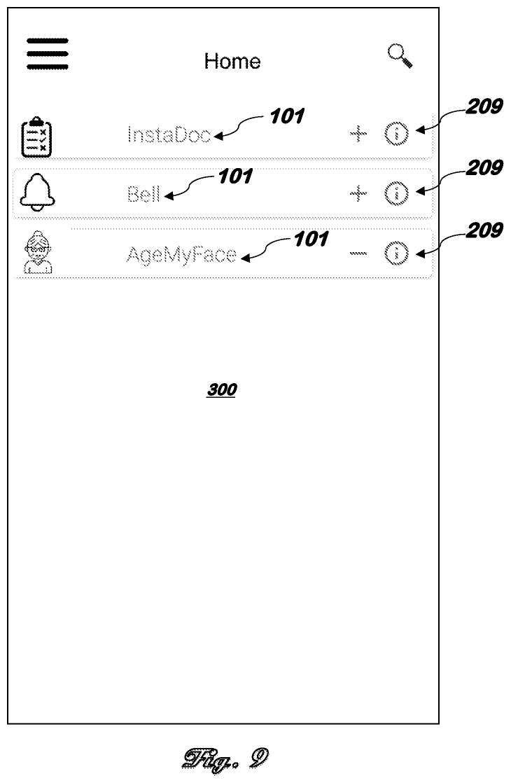

FIGS. 3-9 each show possible embodiments of the present disclosure with end user interface 300, in contrast to analyst user interface 200 (FIG. 2). FIG. 3 is a possible embodiment of a system of the present disclosure with end user interface providing an overall grade and app-specific privacy grades. FIG. 4 is a possible embodiment of a system of the present disclosure with end user interface providing a consumer-facing overall app privacy grade with categories and grades per each category. FIG. 5 is a possible embodiment of a system of the present disclosure with end user interface showing findings 206 regarding CPD treatment indicia 99 of app identifier 101. FIG. 6 is a possible embodiment of a system of the present disclosure with end user interface showing excerpts 208 regarding a third-party app policy. FIG. 7 is a possible embodiment of a system of the present disclosure with end user interface with options to minimize or avoid privacy risk. FIG. 8 is a possible embodiment of a system of the present disclosure with end user interface with search function. FIG. 9 is a possible embodiment of a system of the present disclosure with notification 209.

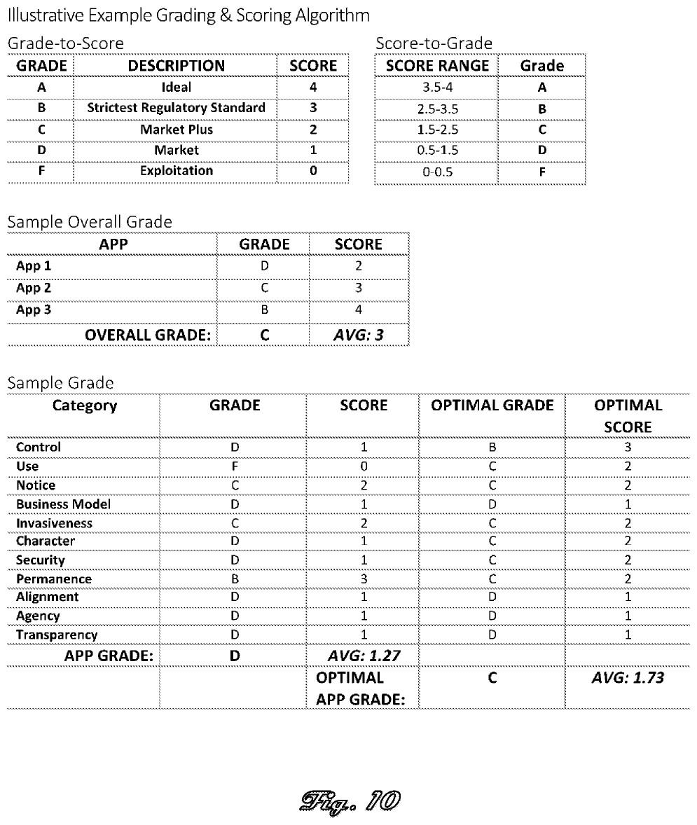

FIG. 10 shows a possible embodiment of the present disclosure with numeric values mapped to letter grades. Grade 104 can have a corresponding numeric value 106 (FIG. 2).

Pole 400 can refer to a privacy performance pole. Pole 400 can refer to classifying a privacy performance 402. There can be at least one or more poles 400, each corresponding to privacy performance relative to a given category.

Privacy performance 402 can refer to how app identifier 101 performs its functions concerning privacy protection of CPD.

By way of non-limiting illustration, the present disclosure can have poles 400 which can help classify a “degree of privacy performance” 402. A given degree of privacy performance can be graded. Privacy performance can be understood as ideal; strictest regulatory standard; market+(“market plus”); market; or exploitation. A non-limiting example is shown in Table 1.

Purported privacy performance 404 can refer to a description of what CPD the app identifier 101 alleges to protect. Findings 206 and excerpts 208 can further describe concrete findings made by a reviewer or analyst to record purported privacy performance 404 of a given third-party app identifier 101.

Actual privacy performance 405 can refer to a description of how app identifier 101 treats CPD. Assessment records 102 for categories 201 can be recorded to measure actual privacy performance 405.

App identifier 101 or “third-party app identifier” 101 can refer to a third-party application. App identifier 101 can be an image, name, or identifier in the sense of a data identifier that has an association with a third-party application. A benefit of app identifier 101 is to permit entry into the system of an app and thereafter to refer to it tangibly for subsequent analysis of each privacy category and CPD treatment indicia 99 to enter findings 206 and excerpts 208 in support of category-based privacy grading.

Assessment record 102 can be entered in a data repository. Assessment record 102 can have recorded data regarding app identifier 101. Assessment record 102 can have recorded data regarding category 201. By way of non-limiting illustration, assessment record 102 can include recorded information regarding CPD treatment indicia 99, privacy policy 212, or terms of service 214. Assessment record 102 can concern any category 201. Assessment record 102 regarding category 201 can be made at or prior to the time of inputting for recordation a grade, finding 206, and/or excerpt 208 concerning category 201. Assessment record 102 can have at least one category 201 and grade 104 regarding third-party app identifier 101. Assessment record 102 can have at least more than one category 201 and corresponding grades 104 regarding third-party app identifier 101. Assessment record 102 can be associated with category 201. Assessment record 102 can be directed to control evaluation of third-party app identifier 101. Assessment record 102 can be directed to notice evaluation of third-party app identifier 101. Assessment record 102 can be directed to business model evaluation of third-party app identifier 101. Assessment record 102 can be directed to agency evaluation of third-party app identifier 101. Assessment record 102 can be directed to invasiveness evaluation of third-party app identifier 101. Assessment record 102 can be directed to security evaluation of third-party app identifier 101. Assessment record 102 can be directed to permanence evaluation of third-party app identifier 101. Assessment record 102 can be directed to alignment evaluation of third-party app identifier 101. Assessment record 102 can be directed to transparency evaluation of third-party app identifier 101. A benefit of assessment record 102 can be to provide a basis for objective evaluation, particularly when used per each category 201.

“Control evaluation” 103 can refer to a record concerning evaluation of the control of a given app identifier 101. It is understood that control does not necessarily mean ownership. In the present disclosure, a benefit and significant refinement of the present disclosure is to create assessment records concerning control of CPD.

Grade 104 can be determined per category 201 regarding an app identifier 101. Grade 104 can be determined overall as to app identifier 101. Per-category and overall grades 104 can be used simultaneously. By way of non-limiting illustration, grade 104 overall can be optionally determined by a weighted average score from underlying grades 104 for two or more categories 201. Grade 104 can be determined by use of guideline 202. A benefit of grade 104 can be to provide a basis of measurable consistency and relative achievement, in this case, with regard to privacy categories. There can be more than one grade 104. For example, grades 104 generally can be entered via user interface 200. Grades 104 can be expressed to denote comparative differentiation, whether letter grades or numeric scores, or descriptions to be understood on a range or spectrum. In a possible embodiment, grades 104 can be scaled to an optimized number and measured against numeric values for letter grades on a per-category basis (FIG. 4). An overall grade for the consumer's device can also be provided (FIG. 3) in addition to app identifier 101 grades. Grade 104 for a specific category 104 can provide category assessment record 102. There can also be an overall grade for app identifier 101.

Identify third-party app (step 1001) can instantiate or receive entry of app identifier 101 to facilitate identification of a third-party app in connection with analysis of CPD treatment indicia 99, findings 206, excerpts 208, and category grades 104. A new app identifier 101 can be identified via user interface 200. Category grades 104 can be entered on a per category basis via user interface 200, thereby assigning various grades 104 corresponding to categories 201. Not all categories 201 need to be graded for a given app identifier 101. Category 201 can have a corresponding category grade 104. In a possible embodiment, upon entry of category grade 104 an at least one finding 206 can be recorded via user interface 200 as part of assessment record 102. In a possible embodiment, category grade 104 and finding 206 can be provided in a private user interface or pre-publication review by an administrator.

Other functions can be added to search or page through categories. Guideline 202 can also be provided to allow quick reference to the operative guideline for the present category. Once the analyst has made progress by entering findings 206 and excerpts 208, the present disclosure can permit such records as to the finding 206 and excerpt 208 to be recorded regarding third-party app identifier 101 and category 201.

End user interface 300 (FIGS. 3-9) can be a visual interface for interacting with the system. In a possible embodiment, end user interface 300 can be displayed on a mobile device screen. Category grades 104 regarding app identifier 101 can be viewed through end user interface 300. Findings 206 and excerpts 208 can be viewed in connection with app identifier 101. In a possible embodiment, analyst user interface 200 can be provided in analyst view (FIG. 2) wherein a specific app identifier 101 can be reviewed and findings 206 and excerpts 208 can be gathered and entered in connection with app identifier 101, categories 201 and related category grades 104. Analyst user interface 200 can provide published forms (FIGS. 3-9) wherein end user interface 300 is then viewable by the public, for example, providing as to category grades 104 concerning app identifier 101.

Category 201 (FIG. 2) can be a category relating to privacy grading criteria. By way of non-limiting illustration, a given category can be one or more selected from the following: Control, Use, Notice, Business Model, Invasiveness, Character, Security, Permanence, Alignment, Agency, and Transparency. Each of the categories 201 can have an assessment record. By way of non-limiting illustration, there can be a control assessment record; a use assessment record; a notice assessment record; a business model assessment record; an invasiveness assessment record; a character assessment record; a security assessment record; a permanence assessment record; an alignment assessment record; an agency assessment record; and a transparency assessment record. Such records can have a corresponding finding 206, and excerpt 208. In a possible embodiment, there can be an at least one excerpt 208 from terms of service 214, privacy policy 212, or any documentation referencing app identifier 101. In a preferred embodiment, category 201 can be associated with assessment record 102. There can be an at least one excerpt 208 from privacy policy 212. Category 201 can be associated with at least one excerpt 208 from privacy policy 212. Category 201 can be associated with at least one excerpt 208 from terms of service 214.

Guideline 202 (referred to in FIG. 2 and Table 1 by way of non-limiting illustration) can provide measures for grading each category 201. In a preferred embodiment, the contents of guideline 202 can be displayed simultaneously in the user interface 200 while input of assessment record 102 can be made. A benefit of guideline 202 can be to facilitate an analyst's reference to specific expanded definitions (Table 1) in relation to a given category 201. A benefit of guideline 202 can be to provide a set of defined observable standards via user interface 200 that analysts can refer to when evaluating app identifier 101 for each given category 201. Said set of defined observable standards (guideline 202) can be enshrined in descriptions for categories 201 as to the ideal; the strictest regulatory standard; the then-current market condition (market); market plus; or exploitative. By way of non-limiting illustration, guideline 202 can provide a plurality of privacy performance standards 400 within a category 201 (FIG. 2). Guideline 202 can thereby provide a standard reference for analysts to use throughout multiple evaluations of apps 101. A benefit of guideline 202 and/or standards 400 can be to provide a tangible interface to refer to privacy performance standards 400.

By way of non-limiting illustration, the following table (Table 1) can provide such guideline 202. A benefit of guideline 202 can be to provide an analyst with a framework on a per-category 201 basis. A benefit of guideline 202 can be to provide an actionable implementation of a framework concerning categories 201 which can have a further benefit of stating a tangible reference in user interface 200 that can be used between or amongst multiple analysts across time and space, remotely. The information in the table below can provide the analyst with specifics of a given category 201 at the time of evaluating such category 201.

By way of non-limiting illustration, when category 201 concerns “control” guideline 202 for control per Table 1 can be displayed to the analyst in the user interface 200. Thereby, a given privacy policy of an app can be evaluated for category 201, in this example, regarding a “control” category 201. In some preferred embodiments, category 201 can refer to privacy gradient 201A.

Gradient 201A can refer to a range of privacy treatment by an app of CPD. Gradient 201A can refer to an ideal, market+, market, regulation, or regulatory standard. Gradient 201A can refer to a standard as described in guideline 202.

Table 1. A non-limiting example of guideline 202 is shown below in Table 1. In some embodiments, an analyst can refer to guideline 202. In an embodiment, guideline 202 can include “poles” 400 each of which correlate with objective criteria for each category as described by non-limiting illustration below. Each category 201 can have a series of poles as shown in the non-limiting illustrative table below. The following evaluation framework describes how multiple categories can be used to enhance objectivity in grading privacy treatment by third-party apps. It can be seen that a wide range of categories can be used to carry out the spirit of the invention. The present invention is not limited to the listed categories per se and can be carried out in a manner consistent with the present disclosure using other categories or with weighted categories or grades.

| | | | | |
|---|---|---|---|---|
| | Strictest Regulatory | | | |
| Ideal | Standard (“SRS”) | Market+ | Market | Exploitation |

Category: Control

| | | | | |
|---|---|---|---|---|
| Consumer unequivocally | Consumer controls | Consumer has substantial | Consumer controls | App effectively has |
| controls collection & | collection & use | control of collection & | collection & use | an unlimited license |
| use of all of their | of CPD. | use of CPD indicated | of CPD | to use, share, and/or |
| data, including the | Opt-in/consent: | by some, but not all, | App free to use, | sell the CPD for any |
| personalization of | Consumer must opt in | of the following: | process, sell, | and all purposes, |
| data acquired outside | to CPD's collection, | Opt-in: | share CPD, etc., | throughout the |
| of the app made | processing, sale, | Consumer must opt in | by default. | universe. |
| possible by the | sharing or other use. | to CPD's collection, | Consumer can | Expressly |
| consumer's provision | Opt-in/consent | processing, sale, | exercise control, | granted/claimed; or |
| of data to the app. | must be: | sharing, or other use. | but must take | Consumer's ownership |
| No use of dark | Informed re: | Opt-in/consent must be: | action to do so, | not expressly |
| patterns e.g., | Categories of CPD | Informed re: | e.g., opt out. | acknowledged & |
| Opt-in & opt-out options | collected or used | Categories of CPD | | consumer not provided |
| with no pre-ticked boxes. | Purpose for collection | collected or used | | means of exercising |
| Opting out is as | by category | Purpose for collection | | ownership as would be |
| easy as opting in | Whether the CPD is | by category | | indicated by, e.g., |
| Consumer must expressly | sold or shared by | Whether the CPD is sold | | opt-out right. |
| opt-in to collection of | category | or shared by category | | |
| their data and to each | Length of time CPD | Length of time CPD | | |
| category of use and by | retained, or the | retained, or the | | |
| each category of user. | criteria used to | criteria used to | | |
| Consumer opt-in | determine the | determine the retention | | |
| must be reaffirmed | retention period, | period, by category. | | |
| periodically/annually | by category. | Categories of sources | | |
| Consumer may revoke | Categories of sources | from which CPD is | | |
| their consent at any | from which CPD is | collected | | |
| time. | collected | Categories of parties to | | |
| Revocation results in | Categories of parties | whom CPD is disclosed. | | |
| immediate deletion of | to whom CPD is | Business or commercial | | |
| all of consumer's data | disclosed. | purpose for collecting, | | |
| throughout the app's | Business or commercial | selling or sharing CPD. | | |
| ecosystem, except as | purpose for collecting, | Right to delete CPD | | |
| required by law. | selling, or sharing | Right to know the above. | | |
| Consumer data retained | CPD. | Freely given (i.e., | | |
| pursuant to legal | Right to delete CPD | requiring more data | | |
| requirement quarantined, | Right to know the | than needed for the | | |
| with access only for use | above. | operation at hand isn't | | |
| as specified by law. | Freely given (i.e., | freely given consent) | | |
| Provider has practices, | requiring more data | Indicated by a clear | | |
| tools, and resources | than needed for the | unambiguous affirmative | | |
| that enhance the | operation at hand isn't | act. | | |
| average consumer's | freely given consent) | CPD collected, used, | | |
| ability to control CPD. | Indicated by a clear | retained, or shared must | | |
| Consumer can readily | unambiguous affirmative | be reasonably necessary | | |
| monetize or otherwise | act. | and proportionate to the | | |
| realize value from their | CPD collected, used, | purpose for which it was | | |
| data at their discretion | retained, or shared | collected or processed, | | |
| | must be reasonably | or for another disclosed | | |
| | necessary and | purpose that is compatible | | |
| | proportionate to the | with the context. | | |
| | purpose for which it | Consumer's CPD is | | |
| | was collected or | deleted upon completion | | |
| | processed, or for | of the consumer's | | |
| | another disclosed | business purposes, | | |
| | purpose that is | except CPD retained | | |
| | compatible with the | as required by law | | |
| | context. | Verified express consent | | |
| | Consumer's CPD is | of guardian required to | | |
| | deleted upon completion | collect, process, use, | | |
| | of the consumer's | etc., minor's data. | | |
| | business purposes, | Consumer has the right | | |
| | except CPD retained | to periodically access | | |
| | as required by law | & review data collected | | |
| | Verified express | about them, regardless | | |
| | consent of guardian | of the data's source. | | |
| | required to collect, | Such data must be | | |
| | process, use, etc., | provided in a commonly | | |
| | minor's data. | used format | | |
| | Consumer has the right | Consumer has the | | |
| | to periodically access | ability to correct | | |
| | & review data collected | inaccurate CPD. | | |
| | about them, regardless | | | |
| | of the data's source. | | | |
| | Such data must be | | | |
| | provided in a commonly | | | |
| | used format | | | |
| | Consumer has the | | | |
| | ability to correct | | | |
| | inaccurate CPD. | | | |

Category: Use

| | | | | |
|---|---|---|---|---|
| Use of consumer's data | CPD use limited to | CPD use limited by | Some limits to use | Data use |
| strictly limited to | Executing the function | some, but not all, of | of CPD collected | unlimited |
| App's function as | for which the CPD was | the following: | by the app beyond | |
| agreed to by consumer, | requested from the | Executing the function | the app's function | |
| related administrative | consumer and activities | for which the CPD was | as agreed to by | |
| and security purposes, | that are reasonably | requested from the | consumer, related | |
| and improvement thereof. | anticipated by the | consumer and activities | administrative and | |
| | context of the business | that are reasonably | security purposes, | |
| | relationship between the | anticipated by the | and improvement | |
| | app and the consumer. | context of the business | thereof. | |
| | Other specifically | relationship between the | Often | |
| | described uses expressly | app and the consumer. | undermined -- use | |
| | consented to by consumer | Other specifically | allowed expanded by | |
| | Consumer has the right to | described uses expressly | Catchall uses | |
| | object to and halt use | consented to by consumer | provided for | |
| | of their CPD for direct | Consumer has the right to | in the terms | |
| | marketing at any time. | object to and halt use of | No limit on use | |
| | | their CPD for direct | of data acquired | |
| | | marketing, at any time. | outside the app | |
| | | | Declining | |
| | | | requested/implied | |
| | | | consent to generally | |
| | | | stated expanded use | |
| | | | precludes provision | |
| | | | of service | |

Category: Notice

| | | | | |
|---|---|---|---|---|
| Express and prominent | Express and prominent | Express and prominent | Generic permission | Notice, if any, |
| notice using plain | notice using plain | notice using plain | requested to access | limited to statement |
| language and/or | language disclosing, | language disclosing | data, device ID, | that the app collects |
| imagery disclosing, | Nature/type/category of | some, but not all, of: | location, etc. | user data, uses |
| Nature/type/category | data to be collected. | Nature/type/category of | | cookies, etc. |
| of data to be collected. | Sources for data | data to be collected. | | |
| Sources for data | collection. | Sources for data | | |
| collection. | Uses, i.e., nature of | collection. | | |
| Uses, i.e., nature of | data processing and its | Uses, i.e., nature of | | |
| data processing and its | purpose(s). | data processing and its | | |
| purpose(s) | Business or commercial | purpose(s) | | |
| Business or commercial | purpose for collecting, | Business or commercial | | |
| purpose for collecting, | selling, or sharing CPD. | purpose for collecting, | | |
| selling, or sharing CPD | Type/categories of users. | selling, or sharing CPD | | |
| Users | Data retention policies. | Type/categories of users | | |
| Data retention policies | Grievance procedures. | Data retention policies | | |
| Grievance procedures | Consumer's CPD control | Grievance procedures | | |
| Consumer's CPD | rights. | Consumer's CPD control | | |
| control rights | App's owner/party to | rights | | |
| App's owner/party to | whom consent is given. | App's owner/party to | | |
| whom consent is given. | | whom consent is given. | | |
| How the app makes money, | | | | |
| particularly the use of | | | | |
| CPD to do so | | | | |
| Invasiveness | | | | |
| Security | | | | |
| Permanence | | | | |
| Alignment | | | | |
| Agency | | | | |

Category: Business Model

| | | | | |
|---|---|---|---|---|
| Provider does not record, | Financial performance | Financial performance is | Financial | App's primary |
| sell, share, distribute | not affected by selling, | enhanced by, but viability | performance depends | purpose is collecting, |
| or otherwise use CPD | sharing, or otherwise | does not depend on, | on capture, use | recording, processing, |
| beyond what is required | using CPD beyond what is | capture, use, and/or | and/or sharing of | mining, sharing, |
| for the function sought | required for the function | sharing of user data | user data beyond | selling, monetizing, |
| by the user or would be | sought by the user or | beyond what is required | what is required for | or otherwise |
| expected by a reasonable | would be expected by a | for the function sought | the function sought | exploiting user data. |
| user in that context; | reasonable user in that | by the user or would be | by the user, or | |
| provider's financial | context | expected by a reasonable | would be expected | |
| performance is not | | user in that context. | by a reasonable user | |
| affected by selling, | | | in that context. | |
| sharing, or otherwise | | | | |
| using CPD beyond what | | | | |
| is required for the | | | | |
| function sought by the | | | | |
| user or would be expected | | | | |
| by a reasonable user in | | | | |
| that context. | | | | |

Category: Invasiveness

| | | | | |
|---|---|---|---|---|
| User data collected | User data collected | User data collection | User data, beyond | User data, beyond |
| only in app and strictly | only in app and strictly | policy includes some, but | what is required | what is required |
| limited to data | limited to data | not all, of the following | for the app's | for the app's |
| Required for app's | Required for app's | limitations: | functionality or | functionality, or what |
| function as agreed to | function as agreed to | User data collected | activities that | would be expected by |
| by consumer, related | by consumer, related | only in app and strictly | would be expected | a reasonable user in |
| administrative and | administrative and | limited to data: | by a reasonable user | that context, is |
| security purposes, and | security purposes, and | Required for app's | in that context, is | collected in app and |
| improvement thereof. | improvement thereof. | function as agreed to | collected in app | outside app without |
| Other data for | Other data for | by consumer, related | and outside the app | user's permission |
| specifically described | specifically described | administrative and | with the user's | Data collected by app |
| uses expressly consented | uses implicitly consented | security purposes, and | permission. | owner is combined with |
| to by consumer | to by consumer. | improvement thereof. | User data collected | data from the public |
| No attempt to collect | No attempt to collect | Other data for | by app owner is | domain and commercial |
| user data outside of app | data outside of app | specifically described | combined with data | sources |
| No attempt to combine | No attempt to combine | uses implicitly consented | from the public | |
| user data collected in | data collected in app, | to by consumer. | domain and | |
| app with data from other | with data from other | No attempt to combine | commercial sources. | |
| sources | sources | data collected in app, | | |
| | | with data from other | | |
| | | sources | | |

Category: Character

| | | | | |
|---|---|---|---|---|
| Clear, explicit, & | Clear, explicit, & | Some, but not all, | Communications | Has specifically lied |
| faithful communication | faithful communication | of the following: | mislead or | about data tracking |
| regarding all data | regarding all data | Clear, explicit, & | obfuscate actual | and or/used practices |
| collection practices. | collection practices. | faithful communication | practices. | or provided false |
| No use of techniques | No use of techniques | regarding all data | Use of techniques | assurances or feigned |
| that bias consumer choice | that bias consumer choice | collection practices. | to bias consumer to | user controls; no |
| against their interest, | against their interest, | No use of techniques | allow collection, | verifiable proof of |
| or that make protecting | or that make protecting | that bias consumer choice | selling, or sharing | reform. |
| CPD more difficult for | CPD more difficult for | against their interest or | of CPD and/or make | |
| the consumer than not | the consumer than not | that make protecting CPD | it difficult to | |
| doing so (e.g., dark | doing so (e.g., dark | more difficult for the | protect CPD (e.g., | |
| patterns) | patterns) | consumer than not doing | dark patterns) | |
| Opt-in & opt-out options | Opt-in & opt-out options | so (e.g., dark patterns) | Use of technology | |
| with no pre-ticked boxes. | with no pre-ticked boxes. | Opt-in & opt-out options | to surreptitiously | |
| Opting out is as | Opting out is as | with no pre-ticked boxes. | collect, sell, | |
| easy as opting in. | easy as opting in. | Opting out is as | share CPD and/or | |
| No use of surreptitious | No use of surreptitious | easy as opting in. | make it difficult | |
| technology | technology | No use of surreptitious | to protect CPD | |
| Proactive innovation, | | technology | | |
| implementation, and | | | | |
| advocacy of CPD- | | | | |
| protective practices | | | | |
| and technology | | | | |
| Readily accessible and | | | | |
| executed grievance | | | | |
| procedures | | | | |

Category: Security

| | | | | |
|---|---|---|---|---|
| Key roles are defined | Proactive vulnerability | Practices include some, | PII data encrypted | No encryption, even |
| enabling accountability | monitoring (including | but not all, of the | in transit (HTTPS) | of credit card |
| around data stewardship, | malware detection) and | following: | Strong passwords | information (a |
| control, and protection | patch management programs | Proactive vulnerability | required | violation) |
| A policy is maintained | are in practice that take | monitoring (including | | 2-factor |
| that addresses | into consideration current | malware detection) and | | authentication is |
| information/data/cyber | risks to the technology | patch management programs | | not available. |
| security for all | environment, and that are | are in practice that take | | Weak passwords |
| personnel. | conducted frequently and | into consideration current | | allowed. |
| CPD is encrypted in | consistently across the | risks to the technology | | Password reset |
| transit and at rest, | technology environment. | environment, and that are | | requires a call |
| and physical access to | User access is | conducted frequently and | | to a call center. |
| facilities that house | appropriately managed and | consistently across the | | No tools available |
| CPD is restricted | monitored through systems | technology environment. | | to check on security |
| All user activity | and procedures that: | User access is | | settings |
| required to enable | limit access as | appropriately managed and | | |
| audit trails is logged. | appropriate, including | monitored through systems | | |
| Change management (how | during onboarding, | and procedures that: | | |
| the organization defines | transfers, and | Limit access as | | |
| new user accounts, | terminations | appropriate, including | | |
| performs software | implement separation of | during onboarding, | | |
| updates, and maintains | duties for user access | transfers, and | | |
| audit trails of any | approvals | terminations | | |
| change to software or | recertify users' access | Implement separation of | | |
| configuration) is | rights on a periodic basis | duties for user access | | |
| standardized (develops | require the use of | approvals | | |
| with code validation | strong, and periodically | Recertify users' access | | |
| from development through | changed, passwords | rights on a periodic basis | | |
| deployment). | utilize multi-factor | Require the use of strong, | | |
| Robust security checkup | authentication leveraging | and periodically changed, | | |
| tools | an application or key fob | passwords | | |
| Login history | to generate an additional | Utilize multi-factor | | |
| Devices logged in | verification code | authentication leveraging | | |
| Ability to remotely log | revoke system access | an application or key fob | | |
| out of devices from | immediately for | to generate an additional | | |
| settings | individuals no longer | verification code | | |
| Alerts | employed by the | Revoke system access | | |
| Third-party service | organization | immediately for individuals | | |
| providers are reviewed | configure access controls | no longer employed by the | | |
| at least annually for | so users operate with only | organization | | |
| compliance with data | those privileges necessary | Configure access controls | | |
| protection policies and | to accomplish their tasks | so users operate with only | | |
| standards | Incident response and | those privileges necessary | | |
| No hardware nor software | resiliency policies and | to accomplish their tasks | | |
| in the environment is | procedures are routinely | Incident response and | | |
| officially retired by | assessed, tested, and | resiliency policies and | | |
| the supplier | periodically updated, | procedures are routinely | | |
| All personnel are | such as contingency and | assessed, tested, and | | |
| screened and background- | disaster recovery plans. | periodically updated, such | | |
| checked prior to hire. | Specific cybersecurity | as contingency and disaster | | |
| A solution is deployed | and resiliency training | recovery plans. | | |
| to remotely manage any | is provided, including | Specific cybersecurity | | |
| company data, which may | phishing exercises to | and resiliency training | | |
| include customer CPD, | help employees identify | is provided, including | | |
| that sits on a connected | phishing emails. | phishing exercises to | | |
| device. | Perimeter security | help employees identify | | |
| | capabilities are | phishing emails. | | |
| | implemented (e.g., | Perimeter security | | |
| | firewalls, intrusion | capabilities are | | |
| | detection systems, email | implemented (e.g., | | |
| | security capabilities, | firewalls, intrusion | | |
| | and web proxy systems | detection systems, email | | |
| | with content filtering) | security capabilities, and | | |
| | that are able to control, | web proxy systems with | | |
| | monitor, and inspect all | content filtering) that | | |
| | incoming and outgoing | are able to control, | | |
| | network traffic to | monitor, and inspect all | | |
| | prevent unauthorized | incoming and outgoing | | |
| | or harmful traffic. | network traffic to prevent | | |
| | | unauthorized or harmful | | |
| | | traffic. | | |

Category: Permanence

| | | | | |
|---|---|---|---|---|
| Consumer's data is | Consumer's data is | Some, but not all, | CPD deleted upon | Data indefinitely |
| deleted upon completion | deleted upon completion | of the following: | consumer request | retained and |
| of the consumer's | of the consumer's | Consumer's data is | subject to user | available to the |
| business purposes | business purposes after | deleted upon completion of | identity, security, | app's owner and/or |
| | a reasonable expressly | the consumer's business | contract and legal | its successors |
| | stated retention period | purposes after a reasonable | (among other) | |
| | to allow for objection | expressly stated retention | protocols. | |
| | and/or add-on request, | period to allow for | | |
| | except data retained as | objection and/or add-on | | |
| | required by law | request, except data | | |
| | CPD deleted upon consumer | retained as required by law | | |
| | request subject to user | CPD deleted upon consumer | | |
| | identity, security, | request subject to user | | |
| | contract and legal | identity, security, | | |
| | (among other) protocols. | contract and legal | | |
| | | (among other) protocols. | | |

Category: Alignment

| | | | | |
|---|---|---|---|---|
| Penalties and enforcement | Penalties and enforcement | Some, but not complete, | Minimal per | All user rights to |
| procedures follow | procedures follow | use of penalty and | incident (<$101) | compensation for |
| standard contract law | standard contract law | enforcement procedures of | or aggregate (<1% | damages waived. |
| Offers alternative | | standard contract law: | sales) penalties | |
| consumer- friendly | | Venue and Procedure, e.g., | for data privacy | |
| expedited dispute | | Expedited court processes | violations. | |
| resolution procedures | | Administrative processes | Enforcement | |
| | | Alternative dispute | procedure(s) much | |
| | | resolution processes | more burdensome | |
| | | Jury trial | than standard | |
| | | Class action | contract law. | |
| | | Other procedures provided | | |
| | | in the jurisdiction | | |
| | | Statute of limitations | | |
| | | of at least 6 months | | |
| | | Damages | | |
| | | Laws, regulations or other | | |
| | | rules used to adjudicate | | |
| | | the dispute | | |

Category: Agency

| | | | | |
|---|---|---|---|---|
| App owner has liability | App owner takes | Some, but not all, | App owner makes | App owner has no |
| for every party who | responsibility for | of the following: | modest efforts to | responsibility for |
| rightfully accesses user | ensuring that every party | App owner takes | guard CPD, e.g., | ensuring use and |
| data failing to comply | who rightfully accesses | responsibility for ensuring | in contracts with | privacy of user data |
| with the data privacy | CPD complies with the | that every party who | employees, third- | in keeping with its |
| agreement between the | data privacy agreement | rightfully accesses CPD | party providers, | agreement with users |
| app and user. | between the app and user. | complies with the data | etc. | by third parties to |
| | App owner has agreements, | privacy agreement between | | whom the app owner |
| | policies, procedures, | the app and user. | | discloses the data. |
| | mechanisms, etc. in place | App owner has agreements, | | |
| | to enforce compliance | policies, procedures, | | |
| | with the data privacy | mechanisms, etc. in place | | |
| | agreement by third | to enforce compliance with | | |
| | parties who rightfully | the data privacy agreement | | |
| | access the data. | by third parties who | | |
| | Agreements with third | rightfully access the data. | | |
| | parties: | Agreements with third | | |
| | Specify CPD is sold | parties: | | |
| | or disclosed only for | Specify CPD is sold | | |
| | limited & specified | or disclosed only for | | |
| | purposes. | limited & specified | | |
| | Obligates the 3^{rd} party | purposes. | | |
| | to comply with privacy | Obligates the 3^{rd} party | | |
| | obligations & protections | to comply with privacy | | |
| | required by SRS | obligations & protections | | |
| | Grants app owner rights | required by SRS | | |
| | to take reasonable steps | Grants app owner rights | | |
| | to ensure that the 3^{rd} | to take reasonable steps | | |
| | party uses the CPD | to ensure that the 3^{rd} | | |
| | consistent with the app | party uses the CPD | | |
| | owner's obligations under | consistent with the app | | |
| | SRS | owner's obligations under | | |
| | Grants the app owner the | SRS | | |
| | right to take reasonable | Grants the app owner the | | |
| | steps to stop & remediate | right to take reasonable | | |
| | unauthorized use of CPD | steps to stop & remediate | | |
| | App owner has mechanisms, | unauthorized use of CPD | | |
| | systems, technology etc. | App owner has mechanisms, | | |
| | to truncate or frustrate | systems, technology etc. | | |
| | unauthorized access or | to truncate or frustrate | | |
| | use of data | unauthorized access or | | |
| | App owner invests | use of data | | |
| | resources in | App owner invests | | |
| | policing/enforcing | resources in | | |
| | compliance sufficient to | policing/enforcing | | |
| | fulfill its obligation | compliance sufficient to | | |
| | App owner notifies user | fulfill its obligation | | |
| | when any data previously | App owner notifies user | | |
| | collected is | when any data previously | | |
| | Disclosed to another user | collected is | | |
| | Used for a purpose other | Disclosed to another user | | |
| | than that for which it | Used for a purpose other | | |
| | was originally collected | than that for which it | | |
| | | was originally collected | | |

Category: Transparency

| | | | | |
|---|---|---|---|---|
| Provider uses language | All aspects of data | Some, but not all, of | General disclosure | Privacy policy, if |
| and has practices, tools, | collection, processing, | the following: | of data collection | any, and/or key terms |
| and resources that | retention, security, & | All aspects of data | for customer | difficult to find |
| enhance the average | disclosure to third | collection, processing, | identification, | |
| consumer's understanding | parties disclosed. | retention, security & | app function & | |
| and CPD control. | Disclosure in plain | disclosure to third | improvement, and | |
| Provider explicitly, | language & user- | parties disclosed. | security. | |
| prominently, and simply | friendly format | Disclosure in plain | Simple statement | |
| discloses any and all | Availability of | language & user- | of whether data | |
| of the provider's uses | disclosure prominently | friendly format | is sold or shared | |
| of CPD | presented for the | Availability of disclosure | with third parties. | |
| Provider explicitly, | consumer. | prominently presented for | | |
| prominently, and simply | | the consumer. | | |
| discloses any and all of | | | | |
| the provider's uses of | | | | |
| CPD to make money. | | | | |

By way of non-limiting illustration, security category 201 assessment record 102 (FIG. 1), can refer to industry-specific requirements:

Sarbanes-Oxley Act (SOX), in particular, sections applicable to data protection applicable in the context of public companies and accounting firms, safeguarding financial data, and controls regarding same by way of non-limiting illustration: encryption, encryption key management, access controls, and security monitoring.

Health Insurance Portability and Accountability Act (HIPAA) as applied to safeguarding healthcare and medical information.

Family Educational Rights and Privacy Act (FERPA) as applied to information protections concerning education records, especially student records.

A benefit of the present disclosure can be to facilitate a rigorous categorical grading system prior to determining an overall grade 104 for a third-party app identifier 101.

Various types of information about app identifier 101 can be stored via assessment record 102. By way of non-limiting illustration, such information can include findings 206, excerpts 208, privacy policy 212, and terms of service 214. A benefit of storing one or more assessment records 102 regarding app identifier 101 can be to provide analysts and reviewers with a means to record or send notes regarding analysis issues or questions, referencing findings, excerpts, or the like.

Finding 206 can be an entry of an at least one factual finding concerning the performance of privacy policy of third-party app identifier 101. Findings 206 can be entered by an analyst. Finding 206 can be recorded in the system of the present disclosure relating to the third-party app and/or a given category 201. Finding 206 can indicate a given app identifier 101's treatment of CPD relative to privacy category 201. Finding 206 can be part of assessment record 102. In some possible embodiments, HTML can be inserted to format the content (bold, italics, bulleted lists, etc.). Findings 206 can be entered by an analyst. Findings 206 can be automatically populated in a back-end database using an administrative interface for analysts to grade an app identifier 101. Findings 206 can automatically populate in the public user interface after entering grade 104. Findings 206 can also refer to how CPD is treated in view of financial statements, advertisement, testing, marketing literature, articles, press releases, a website, social media, or other information.

Excerpt 208 can be an excerpt from a privacy policy. In some embodiments, an analyst can obtain a pertinent excerpt of a privacy policy or other source materials to be recorded as part of the grading record for a given category for a third-party app. Excerpts 208 can be part of assessment record 102. A benefit of excerpt 208 can be to facilitate evaluation of the credibility of a given source. In some embodiments, HTML can be inserted to format the content (bold, italics, bulleted lists, etc.) By way of non-limiting illustration, literature such as an annual report can also be referenced in excerpt 208 as a source. Excerpt 208 can also refer to sources financial statements, advertisement, testing, marketing literature, articles, press releases, a website, social media, or other information. Privacy policy 212 can refer to a privacy policy from a given app identifier 101 provider. Privacy policy 212 can be referenced via link or by the text of the language from a given app's privacy policy. A benefit of privacy policy 212 is to make annotations as assessments 102, findings 206 or excerpts 208 for analysis of a particular category 201 in connection with determining grade 104.

Terms of service 214 can refer to terms of service from a given app identifier 101 provider. Terms of service 214 can be input via link and/or text. A benefit of terms of service 214 is to make annotations as assessments 102, findings 206 or excerpts 208 for analysis of a particular category 201 in connection with determining grade 104.

Stored versions of findings 206, excerpts 208, privacy policy 212, and terms of service 214 can be referred to for grading and review purposes. A benefit of storing findings 206, excerpts 208, privacy policy 212, and terms of service 214 can be to provide readable and clear bases of grade determinations by analysts and reviewers. Another benefit of storing findings 206, excerpts 208, privacy policy 212, and terms of service 214 can be to facilitate collaboration remotely via user interface 200 and to permit further grading and notation via findings 206 and excerpts 208 at subsequent times. A benefit of app identifier 101 can be to index relevant, timely articles with such findings 206 or excerpts 208 for later reference.

Privacy policy 212, terms of service 214 and excerpts 208 can be viewed via user interface 200 to reference or cut and paste excerpts from for analysis and review.

In a possible embodiment, said method for managing privacy assessments of third-party apps can have the steps of:

Comparing a purported treatment (excerpt 208) and an actual treatment (finding 206) of consumer privacy data (CPD) via third-party app identifier 101 to a set of defined observable standards (guideline 202).

Guideline 202 can embody an at least one standard 203. Standard 203 can be set forth in user interface 200. Guideline 202 can provide several standards 203 by providing a definition that can measure against an observation subsequently recorded as a finding 204.

Recording finding 206 can record how privacy data is treated in connection with app identifier 101. Guideline 202 can be presented in analyst user interface 200 for use by an analyst for use and viewing while reviewing app identifier 101 and making findings 204 in connection with how app identifier 101 treats CPD, actual or purported. Purported CPD treatment refers to a record, as recorded by finding or excerpt, describing how CPD is asserted to be handled by a respective third-party app as referred to by use of third-party app identifier 101. Actual CPD treatment refers to a record, as recorded by finding or excerpt, describing how CPD was found to have been handled by a respective third-party app as referred to by use of third-party app identifier 101.

Displaying guideline 202 can provide at least one category, at least one or more categories, at least two or more categories, or an Nth number of categories and Nth number of corresponding grades.

Recording finding 206 regarding the treatment of CPD relative to guideline 202. A benefit of using guideline 202 can be to provide a set of defined observable standards.

Recording an excerpt regarding the purported treatment of CPD after displaying guideline 202.

Recording grade 104 can pertain to category 201.

Generating output of grade 104 can pertain to category 201.

Recording finding regarding actual CPD treatment. Finding can be recorded to reflect purported treatment of consumer privacy data.

Excerpt can be recorded to reflect purported treatment of consumer privacy data.

Recording overall grade can be made after recording at least two or more category grades 104. There can be any number of categories and respective category grades: three, four, five, to the Nth number of category grades.

Recording overall grade pertaining to third-party app identifier 101 can be made after recording at least two or more category grades.

Generating output of grade pertaining to at least two or more category grades.

One having ordinary level of skill in the pertinent art would know how to incorporate the elements of the present disclosure to enable its use based on this specification without undue experimentation. One having ordinary level of skill in the pertinent art would know how to make and use the invention based on the disclosure of this specification. The present disclosure can be implemented on an operating system, including by way of non-limiting illustration, on Android, IOS, Windows, Unix variant, or any other operating system now known or future equivalent. One having ordinary skill in the pertinent art would understand that the recitation of limitations in the claims appended hereto are self-supporting and sufficiently enable one having ordinary skill in the pertinent art to understand how to make and use the invention.

### CONCLUSION

In summary, the present disclosure provides a system to establish privacy ratings of third-party apps for analysts and consumer evaluation across a comprehensive set of categories reflecting the extent to which the app preserves or exploits consumer privacy by its treatment of consumer privacy data.

The foregoing description of the preferred embodiments of the present disclosure has been presented for the purposes of illustration and description. It is not intended to be exhaustive or to limit the present disclosure to the precise form disclosed. Many modifications and variations are possible in light of the above teaching, it is intended that the scope of the present disclosure is not, and need not be, limited by this detailed description, but by the claims and the equivalents to the claims which relate to the present disclosure. Use of punctuation and any articles “a” or “the” in reference to matter claimed shall be construed broadly to uphold the appended claims and equivalents thereto. This specification shall be construed broadly to uphold the claims and equivalents thereto, as set forth by the claims appended hereto. Each of the elements described herein can be directed to being fixed in a non-transitory medium of expression.

What is claimed is:

1. A system for managing privacy performance of apps in a non-transitory medium, comprising:
a third-party app identifier; and
an overall privacy grade is recorded in connection with the third-party app identifier.

2. The system of claim 1, further comprising:
an at least one category corresponds to a category grade.

3. The system of claim 2, further comprising:
an at least one finding.

4. The system of claim 3, further comprising:
the at least one category is recorded in connection with the at least one finding.

5. The system of claim 4, further comprising:
an at least one excerpt.

6. The system of claim 5, further comprising:
the at least one finding is recorded in connection with the third-party app identifier.

7. The system of claim 6, further comprising:
the at least one category is recorded in connection with the at least one excerpt.

8. The system of claim 7, wherein:
an assessment record is recorded in connection with a first category.

9. The system of claim 8, wherein:
the assessment record is recorded with a second category regarding the third-party app identifier.

10. The system of claim 8, wherein:
the assessment record is directed to a control category in reference to the third-party app identifier.

11. The system of claim 8, wherein:
the assessment record is directed to a notice category in reference to of the third-party app identifier.

12. The system of claim 8, wherein:
the assessment record is directed to a business model category in reference to of the third-party app identifier.

13. The system of claim 8, wherein:
the assessment record is directed to an agency category in reference to of the third-party app identifier.

14. The system of claim 8, wherein:
the assessment record is directed to an invasiveness category in reference to of the third-party app identifier.

15. The system of claim 8, wherein:
the assessment record is directed to a security category in reference to of the third-party app identifier.

16. The system of claim 8, wherein:
the assessment record is directed to an alignment category in reference to of the third-party app identifier.

17. The system of claim 8, wherein:
the assessment record is directed to a transparency category in reference to of the third-party app identifier.

18. The system of claim 17, wherein:
the at least one finding describes a consumer privacy data (CPD) treatment indicia.

19. The system of claim 17, further comprising:
the at least one excerpt describes a terms of service document.

20. The system of claim 17, further comprising:
the at least one excerpt in reference to a privacy policy.

21. The system of claim 18, further comprising:
the category grade is based on the at least one finding.

22. The system of claim 18, further comprising:
the at least one finding comprises: an omission of the CPD treatment indicia.

23. The system of claim 22, further comprising:
a control assessment record.

24. The system of claim 23, further comprising:
a use assessment record.

25. The system of claim 24, further comprising:
a grade is assignable to the at least one category.

26. The system of claim 25, further comprising:
an overall grade assigned in connection with the app identifier.

27. The system of claim 26, further comprising:
a group of categories concerning privacy relating to the app identifier.

28. The system of claim 27, further comprising:
the at least one category is used to determine an overall privacy grade of the third-party application.

29. A method for managing privacy assessments of third-party apps, comprising the steps of:
identifying an app identifier; and
reviewing a privacy policy associated with the app identifier.

30. The method of claim 29, further comprising:
selecting a category via an analyst user interface.

31. The method of claim 30, further comprising:
entering an at least one finding.

32. The method of claim 31, further comprising:
entering an excerpt.

33. The method of claim 32, further comprising:
entering a category grade.

34. The method of claim 33, wherein:
upon entering the category grade, the at least one finding is automatically populated in a public-facing user interface.

35. The method of claim 34, further comprising:
saving a category assessment record.

36. The method of claim 35, further comprising:
publishing the category assessment record.

37. The method of claim 36, further comprising:
recording the at least one finding regarding an actual treatment of a consumer privacy data.

38. The method of claim 37, further comprising:
the at least one finding is recorded to reflect a purported treatment of the consumer privacy data.

39. The method of claim 38, further comprising:
the excerpt is recorded to reflect the purported treatment of the consumer privacy data.

40. The method of claim 37, further comprising:
recording an overall grade after recording an at least two category grades.

41. The method of claim 40, further comprising:
recording an overall grade pertaining to the app identifier after recording the at least two category grades.

42. The method of claim 41, further comprising:
generating an output of the overall grade pertaining to the at least two category grades.
